(19) United States
(12) Patent Application Publication
(10) Pub. No.: US 2025/0065284 A1
(43) Pub. Date: Feb. 27, 2025

(54) MODULAR PREMIX BATCHING AND DISPENSING SYSTEM

(71) Applicant: Statera Ag, LLC, Noblesville, IN (US)

(72) Inventors: Jared Froetschner, Fishers, IN (US); Adam Froetschner, Dodge City, KS (US); Ryan Stapleton, Meade, KS (US); Jarret Stapleton, Meade, KS (US); Stetson Rasberry, Sublette, KS (US); Shawn Stapleton, Sublette, KS (US)

(21) Appl. No.: 18/718,876

(22) PCT Filed: Dec. 14, 2022
(86) PCT No.: PCT/US2022/081498

§ 371 Date: Jun. 12, 2024

Related U.S. Application Data
(60) Provisional application No. 63/265,368, filed on Dec. 14, 2021.

(51) Int. Cl. B01F 33/84; B01F 23/53; B01F 33/80; B01F 35/21

(52) U.S. Cl. CPC B01F 33/84; B01F 23/53; B01F 33/834; B01F 35/2115; B01F 35/2117

(57) ABSTRACT

A modular premix batching and dispensing system for crop micronutrient application includes a skid-based batching and mixing system with a first dry bin to store a dry mineral sulfate; a second dry bin to store an amino acid; a water source; a reactor having a mixing mechanism and connected with the water source and the dry bins; and a first controller configured to automatically control transfer of water, dry mineral sulfate, and amino acid to the reactor and to control operation of the reactor; and a skid-based day tank system with at least one day tank configured to store mineral amino acid complex received from the reactor; and a dispensing network configured to selectively transfer the mineral amino acid complex to an application receptable. An associated method of preparing and delivering micronutrients using a modular premix batching and dispensing system is also described.

### CROSS REFERENCE

This application claims priority to and is a continuation of U.S. Provisional Application No. 63/265,368, filed Dec. 14, 2021, the entirety of which is hereby incorporated by reference.

### FIELD OF INVENTION

The present disclosure is directed to crop nutrition application and, more particularly, to a micronutrient premix batching and dispensing system.

### BACKGROUND

The field of crop nutrition is a new area of focus in crop farming. Currently, the industry uses broad spectrum products (e.g., Micro 600) that are formulated to address perceived nutrient deficiencies. While broad spectrum products may be useful in some circumstances, it is difficult to assess the value of the total blend when addressing one perceived deficiency.

There are methods of assessing micronutrient deficiencies in crop pants and/or formulating micronutrient premixes in development that have been customized to address those deficiencies. These methods advantageously enable crop producers to selectively apply the micronutrients required to optimize crop production at a minimal cost. Micronutrient deficiencies may be determined through analysis of leaf tissue and/or stem tissue. Subsequently, micronutrient mixtures and formulations suitable for application to crop plants may be applied to address such deficiencies.

These foliar products come in a package form, with various sulfates mixed with products such as fulvic acid. However, these are blanket products that are poorly absorbed. Additionally, foliar products are mixed in very dilute mixtures and shipped to the applicator, where the applicator and farmer must pay for hauling water. Therefore, delivery and application of such foliar products currently presents significant issues in the form of inefficient and ineffective mixing and high cost of packaging and delivery to the location of application.

Therefore, it would be desirable to provide an apparatus and method for the application of micronutrient mixtures and formulations, as well as other crop and soil nutrients and chemical applications.

### SUMMARY

According to an aspect of the present disclosure, there is provided a modular premix batching and dispensing system for crop micronutrient application that includes a skid-based batching and mixing system with a first dry bin configured to store a dry mineral sulfate; a second dry bin configured to store an amino acid; a water source; a reactor having a mixing mechanism and being connected with the water source, the first dry bin, and the second dry bin and configured to accept quantities of water, dry mineral sulfate, and amino acid therefrom; and a first controller configured to control at least one of (a) transfer of water, dry mineral sulfate, and amino acid to the reactor and (b) operation of the reactor; and a skid-based day tank system with at least one day tank configured to store a mineral amino acid complex received from the reactor; and a dispensing network configured to selectively transfer specified quantities of the mineral amino acid complex to an application receptable.

According to another aspect of the present disclosure, the modular premix batching and dispensing system also includes at least one of a scale and a load cell configured to monitor a weight of contents contained within at least one of the first dry bin, second dry bin, and reactor, the scale or load cell being in communication with the first controller and configured to generate and output a weight signal as a function of a current measured weight within at least one of the first dry bin, second dry bin, and reactor to the first controller; and wherein the weight signal is one of one or more variables used by the first controller to control at least one of (a) the transfer of water, dry mineral sulfate, and amino acid to the reactor and (b) operation of the reactor.

According to another aspect of the present disclosure, the modular premix batching and dispensing system also includes a thermocouple configured to monitor a temperature within the reactor, the thermocouple being in communication with the first controller and configured to generate and output a temperature signal as a function of a current measured temperature within the reactor to the first controller; and wherein the temperature signal is one of one or more variables used by the first controller to control operation of the reactor.

According to another aspect of the present disclosure, the modular premix batching and dispensing system also includes a timer integral with or in communication with the first controller, the timer configured to generate and output a time signal as a function of a total time since commencement of a process within the reactor for a current batch size to the first controller; wherein the first controller further comprises a memory containing a table of reference times for process completion for at least one reference batch size; and wherein the time signal is one of one or more variables used by the first controller to control operation of the reactor, the first controller being configured to compare the time signal received from the timer with a corresponding reference time for a corresponding reference batch size from the table of reference times for process completion.

According to another aspect of the present disclosure, the modular premix batching and dispensing system includes a heated reactor with a heat source in thermal communication with a heat exchanger and wherein the heat exchanger is in fluid communication with a reactor tank of the heated reactor.

According to another aspect of the present disclosure, a method of preparing and delivering micronutrients using embodiments of the modular premix batching and dispensing system as described herein includes the steps of transferring a desired quantity of at least one dry mineral sulfate from the first dry bin to the reactor; delivering water from the water source to the reactor in an amount to produce a desired dilution ratio of the dry mineral sulfate; initiating operation of the mixing mechanism of the reactor to dissolve the dry mineral sulfate to the desired dilution ratio; transferring an amino acid from the second dry bin to the reactor and initiating a chelation reaction in the reactor; and transferring the mineral amino acid complex resulting from the chelation reaction to the at least one day tank.

These aspects are merely illustrative of the innumerable aspects associated with the present disclosure and should not be deemed as limiting in any manner. This and other aspects, features and advantages of the present disclosure will become apparent from the following detailed description when taken in conjunction with the referenced drawings.

### DESCRIPTION OF DRAWINGS

Reference is now made more particularly to the drawings, which illustrate the best presently known mode of carrying out the disclosure and wherein similar reference characters indicate the same parts throughout the views.

FIG. 1 is a schematic illustration of a modular premix batching and dispensing system according to an embodiment of the present disclosure.

FIG. 2 is a block diagram of a control layout for a modular premix batching and dispensing system according to an embodiment of the present disclosure.

FIG. 3 is a basic process flow chart for use of a modular premix batching and dispensing system according to an embodiment of the present disclosure.

FIG. 4 is a schematic illustration of another embodiment of a reactor and mixing station suitable for use in modular premix batching and dispensing systems according to the present disclosure.

FIG. 5 is a basic process flow chart for use of the reactor and mixing station of FIG. 4.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” or “approximately” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

A modular process skid is a process system contained within a frame that allows the process system to be easily transported. Individual skids can contain complete process systems and multiple process skids can be combined to create larger process systems or entire portable plants. An example of a multi-skid process system might include a raw materials skid, a utilities skid and a processing unit which work in tandem.

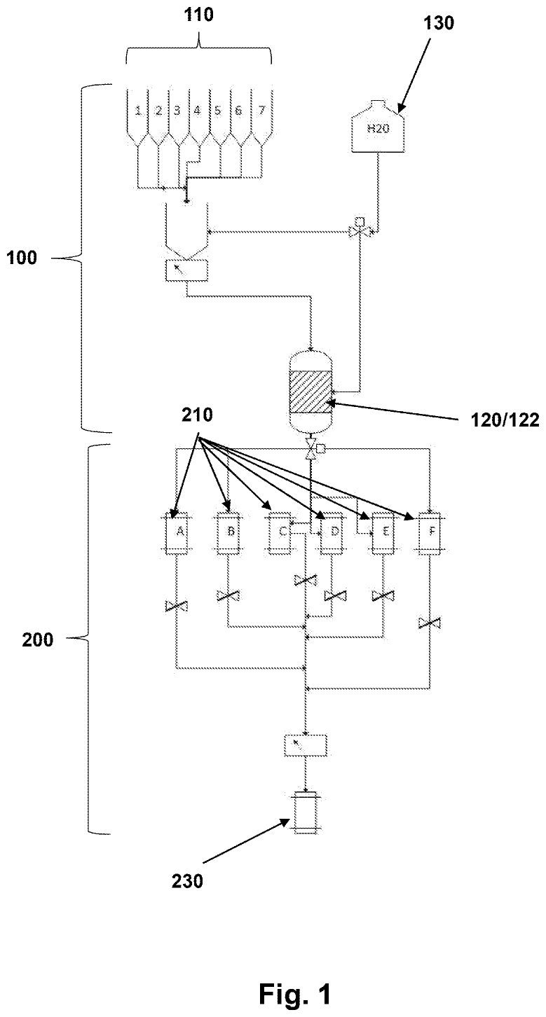

FIG. 1 schematically illustrates the basic components for a modular process skid or skids for preparation and delivery of micronutrient delivery systems, for example, mineral amino acid complexes. The modular process skid may include two components. The first is a mineral amino acid complex batching and mixing system 100. The second is a day tank system 200 capable of dispersing an appropriate amount of mixed mineral amino acid complex. The batching and mixing system 100 and day tank system 200 may be located on the same process skid or on separate skids that may be joined.

The batching and mixing system 100 includes one or more dry bins 110 that may store quantities of dry mineral sulfates, for example, copper sulfate, manganous sulfate, iron sulfate, borosulfate, molybdenum sulfate, or zinc sulfate. The batching and mixing system 100 further includes a reactor 120 having an impeller or other mixing mechanism 122, preferably a low-speed impeller. The dry bins 110 and reactor 120 may be located on the same skid or separate skids.

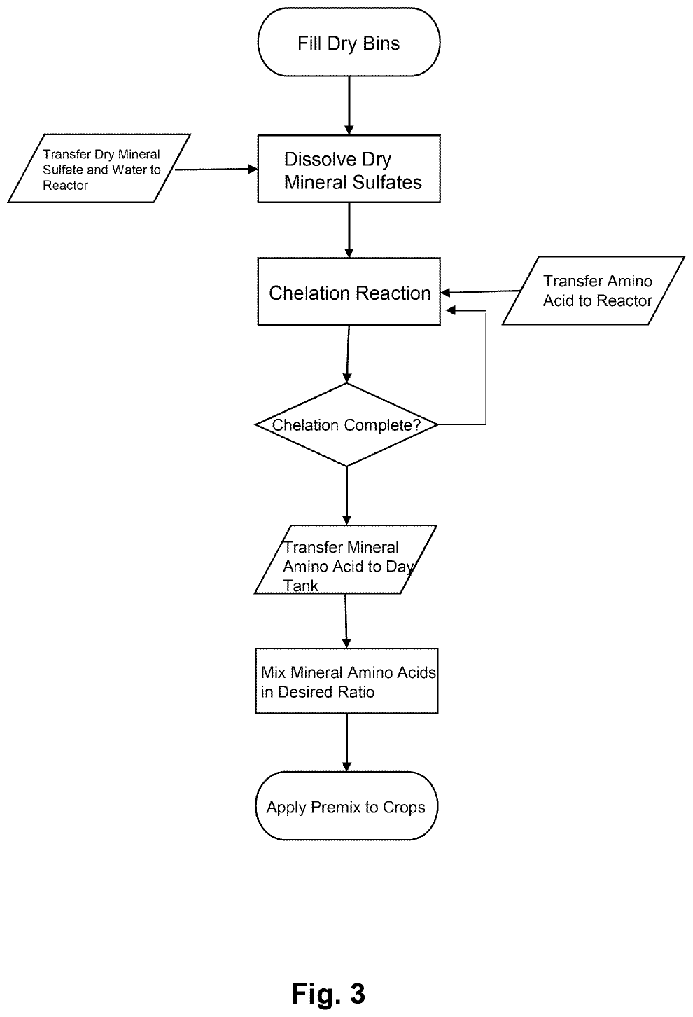

FIG. 3 illustrates a simplified version of the process associated with the present disclosure. At the initiation of the mixing process, a quantity of the applicable mineral sulfate(s) is automatically transferred, for example, by a gravity feed system, into the reactor 120. The quantity of mineral sulfate(s) transferred may be monitored and controlled by monitoring the weight of the associated material. For example, a scale or load cell may be used to track the change in material weight within the dry bin 110 and/or the reactor 120. A system controller 116 may be incorporated into the batching and mixing system 100 to control the transfer of the dry mineral sulfate(s).

Once the appropriate amount of dry mineral sulfate(s) has been transferred to the reactor 120, water is added to the reactor 120 in an appropriate amount to produce a desired dilution ratio. The system controller 116 may trigger the supply of water to the reactor 120. The batching and mixing system 100 may be provided with a water tank 130 to facilitate the process. The incorporation of a water tank 130 is advantageous in providing for a more self-contained process skid; however, other embodiments may incorporate a direct connection to a reliable water source rather than a tank where such a source is available.

Once water is added to the reactor 120, it is turned on and the impeller or other mixing mechanism operates to dissolve the dry mineral sulfate(s) into the water at the desired dilution ratio. A thermostat 124, for example, a thermocouple, may be incorporated into the reactor 120 to help determine when the dissolution cycle is complete because the reaction occurring within the reactor 120 is exothermic in nature. A table of reference temperatures for process completion for various reference batch size may be stored in a memory of the system controller 116. The thermostat 124, which may be integral with or in communication with the system controller 116, may generate and output a temperature signal to the system controller 116, which compares the temperature signal received from the thermostat 124 with a corresponding reference temperature for a corresponding reference batch size from the table of reference temperatures for process completion. When the actual temperature since commencement of the dissolution process reaches the expected temperature value, the system controller 116 will register the dissolution process as being complete.

In other embodiments, a timer 128 may be used to control the process. A table of reference times for process completion for various reference batch size may be stored in a memory of the system controller 116. The timer 128, which may be integral with or in communication with the system controller 116, may generate and output a time signal to the system controller 116, which compares the time signal received from the timer 128 with a corresponding reference time for a corresponding reference batch size from the table of reference times for process completion. When the actual time since commencement of operation of the reactor reaches the expected time value, the system controller 116 will register the dissolution process as being complete.

Upon completion of the dissolution cycle, an amino acid, for example, glycine, lysine, arginine, histidine, or valine, stored in its own dry bin 110 is transferred to the reactor 120 with the quantity transferred to again be measured by weight. The amino acid initiates a chelation reaction. Progress of this chelation reaction may be determined again by the thermostat 124, or a second thermostat. The chelation reaction is endothermic, so the thermostat 124 may monitor temperature reduction and generate and output a temperature signal as a function of a current measured temperature within the reactor to the system controller 116. A table of reference temperatures for completion of the chelation reaction for various reference batch sizes may be stored in a memory of the system controller 116. The thermostat 124 may generate and output a temperature signal to the system controller 116, which compares the temperature signal received from the thermostat 124 with a corresponding reference temperature for a corresponding reference batch size from the table of reference temperatures for completion of the chelation reaction. When the actual temperature since commencement of the chelation reaction reaches the expected time value, the system controller 116 will register the process as being complete.

Once the chelation reaction is complete, a pump 140 transfers the resulting mineral amino acid complex(es) to the day tank system 200. The mineral component of the mineral amino acid complex may comprise, for example, calcium, magnesium, silicon, iron, molybdenum, boron, copper, manganese, sodium, zinc, nickel, chlorine, selenium, vanadium, cobalt, or a combination of any thereof. More specifically, the mineral may comprise, for example, zinc, copper, manganese, boron, molybdenum, iron, potassium, or a combination thereof. Pumping of the mineral amino acid complex(es) may be initiated automatically upon completion of the chelation reaction. Each mineral amino acid complex may be transferred to its own day tank 210 where it is stored until dispensed for an application.

To create an appropriate application premix from the various mineral amino acid complexes in the day tank system 200, the system 200 may include a controller 220 that accepts manual inputs, receives inputs from external systems, or calculates internally the required ratios of the mineral amino acid complexes based on, for example, the starting and ending of tissue mineral levels, the mineral Absorption Coefficient and the size of the field, and controls dispensing of the appropriate mineral amino acid complexes in the appropriate amounts to an application drum or other receptacle 230. Dispensing of the various mineral amino acid complexes to the application drum is controlled by suitable valving, flowmeters, load cells, scales, or other process controls 240. The resulting mineral amino acid complex premix solution may then be applied to crops.

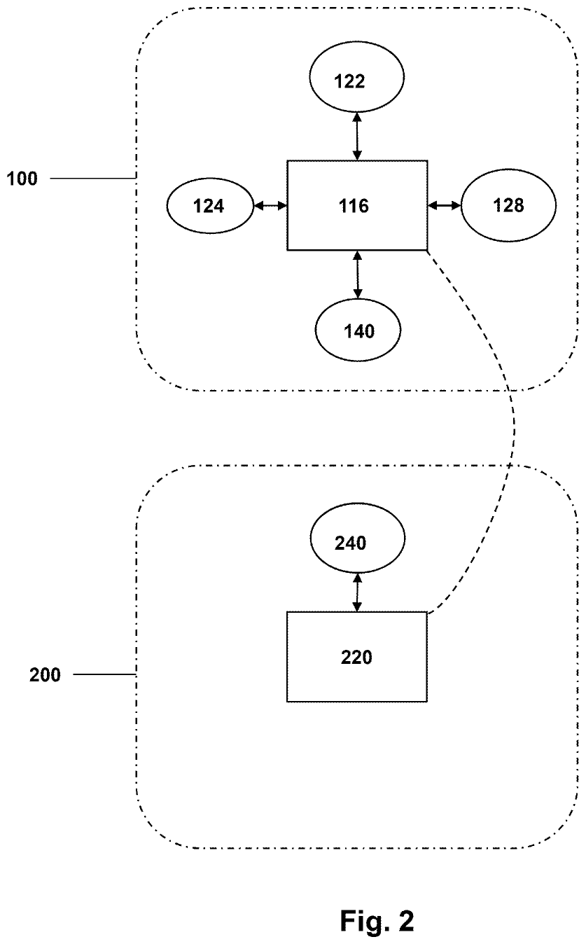

Controller 220 may be the same controller 116 as used with the batching and mixing system 100 or a separate controller that may be in communication with system controller 116, for example, as illustrated in FIG. 2.

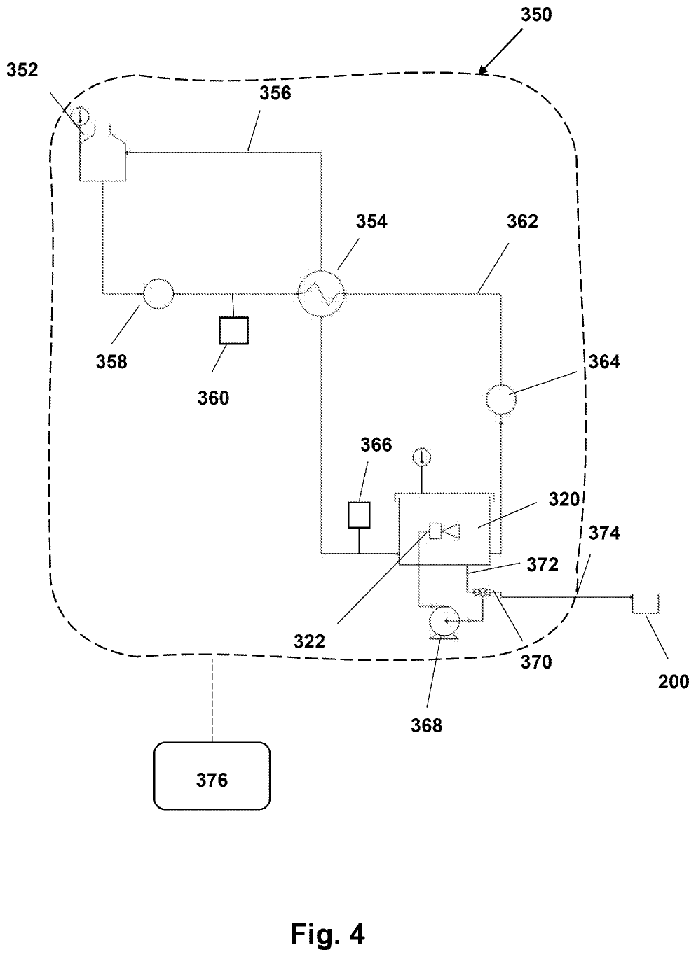

FIG. 4 illustrates a heated reactor mechanism 350 from another embodiment of a modular process skid according to the present disclosure. It has been found that conducting the mixing and chelation processes at elevated temperatures, for example, at or above approximately 140° F., results in a significant improvement in the time required to completely dissolve the dry mineral sulfate(s) and produce the desired mineral amino acid complex. For example, maintaining a temperature of between approximately 140° F. and approximately 160° F. has been found to reduce the required reaction time by as much as 50%. While temperatures within the foregoing approximately 140° F. to approximately 160° F. have yielded superior results, it has been found that process temperatures above approximately 130° F. also produce improved process results. In one test, a process temperature of 120° F. resulted in a chelation reaction completion time of 1,440 seconds for a boron lysinate solution, while a process temperature of 135° F. produced a reaction competition time of 780 seconds, representing a 46% reduction.

The heated reactor mechanism 350 would generally be inserted into a modular process skid as described above where the reactor 120 has been previously identified. The heated reactor mechanism 350 may include a boiler 352 that supplies hot water to a heat exchanger 354 through a hot water loop 356. In an exemplary embodiment, a 28.5K BTU output boiler may be utilized. In another exemplary embodiment, the heat exchanger 354 may be a tube-style heat exchanger and heated water from the boiler 352 is delivered to the tubes of the heat exchanger 354. A variety of heat exchanger types may be incorporated into the heated reactor mechanism 350. A hot water pump 358 circulates water through the hot water loop 356. The boiler 352, heat exchanger 354, and/or hot water loop 356 may be provided with one or more thermostats 360 to monitor the temperature of the water being produced by the boiler 352 and/or passing through the hot water loop 356 to the heat exchanger 354.

The heat transfer baffles of the heat exchanger 354, in turn, are fluidly connected via a process fluid loop 362 with a reactor 320 within which solution water is mixed with the dry mineral sulfate(s). The process fluid circulating through the process fluid loop may initially be entirely water and transition to a water and mineral sulfate solution mix and a water, mineral, and amino acid solution mix as the reactions proceed. A solution recirculation pump 364 circulates the process fluid between the reactor 320 and heat exchanger 354 to bring the process fluid to and maintain it at a desired process temperature. One or more thermostats 366 may be used in the water/solution loop 362 and/or reactor 320 to monitor the process fluid and determine when the process fluid reaches the desired process temperature.

The reactor 320 is provided with a mixer 322. The mixer 322 may be an impeller or similar mechanism or, in a preferred embodiment, a Venturi mixer. In embodiments utilizing a Venturi mixer, a recirculation pump 368 draws process fluid from the reactor 320 and pumps it back to the Venturi mixer. A 3-way flow control valve 370 may be provided in a recirculation line 372 from the reactor 320 to the solution recirculation pump 364. An output line 374 may also be connected to the 3-way flow control valve 370 to deliver the resulting mineral amino acid complex(es) from the reactor 320 to, for example, the day tank system 200 or any form of packaging or other product delivery means upon completion of the process. During reactor 320 operation, the 3-way flow control valve 370 directs fluid flow from the reactor 320 to the solution recirculation pump 364. Upon process completion, the 3-way flow control valve 370 may be shifted, either manually or automatically, to direct fluid flow from the reactor 320 to the day tank system 200 or other delivery point or package.

A controller 376 may be operatively connected with the boiler 320, hot water pump 358, heat exchanger 354, solution recirculation pump 364, mixer 322, and the thermostats 360, 366 to direct operation of these components as a function of, at least in part, the temperatures of the fluid flows within the respective recirculation loops. For example, delivery of dry mineral sulfate(s) and operation of the mixer 322 may be triggered when the temperature of the water in the solution loop 362 reaches a desired process temperature as measured by the thermostat(s) 366 monitoring that portion of the heated reactor mechanism 350. Further, the operating temperature of the boiler 352 may, for example, be adjusted if the thermostat(s) 360 associated with the hot water loop 356 detect an undesired increase/decrease in the temperature of the water in the hot water loop 356 or if the solution water in the solution loop 362 is taking longer than expected to reach the desired process temperature. The controller 376 may also be in communication with the 3-way flow control valve 370 and operable to switch the valve 370 to direct fluid flow from the reactor 320 to the desired delivery point upon completion of the mixing and chelation processes.

The controller 376 may communicate with the various components of the heated reactor mechanism 350 by a wired or wireless, for example Wi-Fi or Bluetooth technology, connection. The controller 376 may also control other aspects of the modular process skid or be a separate controller that is in communication with one or more other controllers associated with the skid system.

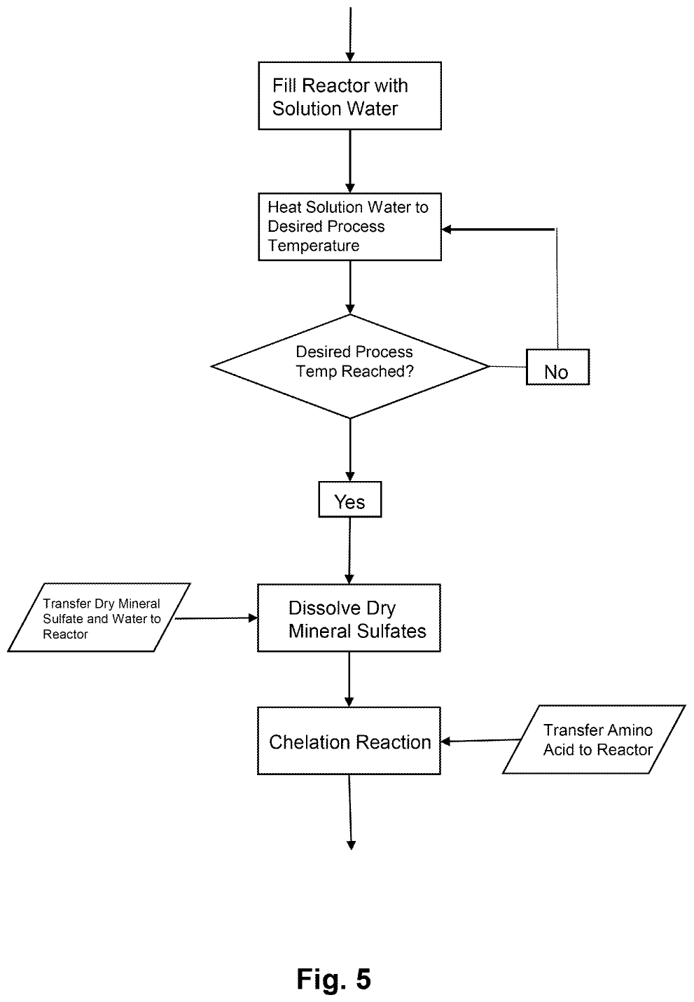

FIG. 5 presents a process flow diagram for use of the heated reactor mechanism 350 described above. In general, but not exclusively, the following steps may supplement the “Transfer Dry Mineral Sulfate and Water to Reactor”, “Dissolve Dry Mineral Sulfates”, and/or “Chelation Reaction” steps of FIG. 3. Water is first added to the reactor 320, and the solution recirculation pump 364 begins to circulate water through the solution loop 362. The water within the hot water loop 356 may already be circulating through the hot water loop 356 at the desired temperature or, if not, the boiler 352 and/or hot water pump 358 may be adjusted as necessary to begin raising the water temperature in the hot water loop 356 until it reaches a desired temperature. The temperature of the water in the solution loop 362 may be monitored and, when the thermostat 360 indicates that the water has reached the desired process temperature, delivery of the appropriate amount of dry mineral sulfate to the reactor 320 and operation of the mixer 322 is initiated. The thermostat(s) 366 may continue to monitor the fluid temperature in the solution loop 362 and the controller 376 may adjust operation of the boiler 322 and/or the other components of the heated reactor mechanism 350 to maintain the desired process temperature during the mixing and chelation processes until completed. Process monitoring may be controlled in a similar manner as described above, for example, with timers and/or thermocouples

Embodiments of the present disclosure allow for specifically formulated mineral amino acid complex premixes to be batch produced at the site of application, which significantly reduces the costs associated with the process. Shipment of completed product, with the significant attendant weight of water, and need for packaging materials are eliminated. Further, automation of the batching, mixing, and dispensing processes, significantly increases efficiency in the amount of base ingredients used and finished premix produced. Only the amounts actually needed are used and produced, and waste is significantly reduced or eliminated.

The preferred embodiments of the disclosure have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present invention should not be limited by the above-described exemplary embodiment but should be defined only in accordance with the following claims appended hereto and their equivalents.

1. A modular premix batching and dispensing system for crop micronutrient application, comprising:
a skid-based batching and mixing system further comprising:
at least a first dry bin configured to store a dry mineral sulfate;
at least a second dry bin configured to store an amino acid;
a water source;
a reactor having a mixing mechanism and connected with the water source, the first dry bin, and the second dry bin and configured to accept quantities of water, dry mineral sulfate, and amino acid therefrom; and
at least a first controller configured to control at least one of (a) transfer of water, dry mineral sulfate, and amino acid to the reactor and (b) operation of the reactor; and
a skid-based day tank system further comprising:
at least one day tank configured to store a mineral amino acid complex received from the reactor; and
a dispensing network configured to selectively transfer specified quantities of the mineral amino acid complex to an application receptable.

2. The modular premix batching and dispensing system as set forth in claim 1, wherein the water source comprises a water tank.

3. The modular premix batching and dispensing system as set forth in claim 1,
wherein the skid-based batching and mixing system further comprises at least one of a scale and a load cell configured to monitor a weight of contents contained within at least one of the first dry bin, second dry bin, and reactor, the scale or load cell being in communication with the first controller and configured to generate and output a weight signal as a function of a current measured weight within at least one of the first dry bin, second dry bin, and reactor to the first controller; and
wherein the weight signal is one of one or more variables used by the first controller to control at least one of (a) the transfer of water, dry mineral sulfate, and amino acid to the reactor and (b) operation of the reactor.

4. The modular premix batching and dispensing system as set forth in claim 1, wherein the mixing mechanism comprises an impeller.

5. The modular premix batching and dispensing system as set forth in claim 1, wherein the mixing mechanism comprises a low-speed impeller.

6. The modular premix batching and dispensing system as set forth in claim 1, further comprising:
a thermostat configured to monitor a temperature within the reactor, the thermostat being in communication with the first controller and configured to generate and output a temperature signal as a function at least of a current measured temperature within the reactor to the first controller;
wherein the first controller further comprises a memory containing a table of reference temperatures for process completion for at least one reference batch size; and
wherein the temperature signal is one of one or more variables used by the first controller to control at least one of (a) transfer of water, dry mineral sulfate, and amino acid to the reactor and (b) operation of the reactor, the first controller being configured to compare the temperature signal received from the thermostat with a corresponding reference temperature for a corresponding reference batch size from the table of reference temperature for process completion.

7. The modular premix batching and dispensing system as set forth in claim 1, further comprising:
a timer integral with or in communication with the first controller, the timer configured to generate and output a time signal as a function of a total time since commencement of operation of the reactor to the first controller;
wherein the first controller further comprises a memory containing a table of reference times for process completion for at least one reference batch size; and
wherein the time signal is one of one or more variables used by the first controller to control at least one of (a) transfer of water, dry mineral sulfate, and amino acid to the reactor and (b) operation of the reactor, the first controller being configured to compare the time signal received from the timer with a corresponding reference time for a corresponding reference batch size from the table of reference times for process completion.

8. The modular premix batching and dispensing system as set forth in claim 1, further comprising a pump configured to transfer the quantity of mineral amino acid complex from the reactor to the at least one day tank.

9. The modular premix batching and dispensing system as set forth in claim 1, further comprising at least a second controller in communication with the dispensing network and configured to control operation of at least the dispensing network.

10. The modular premix batching and dispensing system as set forth in claim 1, wherein the dispensing network comprises at least one of a valve, flowmeter, load cell, and scale.

11. The modular premix batching and dispensing system as set forth in claim 1, wherein the reactor is a heated reactor.

12. The modular premix batching and dispensing system as set forth in claim 11, wherein the heated reactor further comprises a heat source in thermal communication with a heat exchanger and wherein the heat exchanger is in fluid communication with a reactor tank of the heated reactor.

13. The modular premix batching and dispensing system as set forth in claim 11, wherein the heated reactor comprises a heat source, a hot water loop, and a heat exchanger, wherein the heat source is configured to heat water passing through the hot water loop and wherein the hot water loop is configured to circulate heated water through the heat exchanger.

14. The modular premix batching and dispensing system as set forth in claim 11, wherein the heat source comprises a boiler.

15. The modular premix batching and dispensing system as set forth in claim 13, further comprising a hot water loop thermally connecting the heat source with the heat exchanger and a process fluid loop configured to circulate process fluid between the heat exchanger and a reactor tank of the heated reactor.

16. The modular premix batching and dispensing system as set forth in claim 15, further comprising at least one thermostat configured to monitor a fluid temperature within at least one of the hot water loop, process fluid loop, and reactor tank.

17. The modular premix batching and dispensing system as set forth in claim 1, wherein the mixing mechanism comprises a Venturi mixer.

18. The modular premix batching and dispensing system as set forth in claim 17, further comprising a recirculation loop in fluid communication with the Venturi mixer.

19. The modular premix batching and dispensing system as set forth in claim 18, further comprising at least a first flow control valve in fluid communication with the recirculation loop, the first flow control valve configured to selectively direct flow of fluid through the recirculation loop or to an output line.

20. A method of preparing and delivering micronutrients using a modular premix batching and dispensing system as set forth in claim 1, comprising the steps of:
transferring a desired quantity of the dry mineral sulfate from the first dry bin to the reactor;
delivering water from the water source to the reactor in an amount to produce a desired dilution ratio of the dry mineral sulfate;
initiating operation of the mixing mechanism of the reactor to dissolve the dry mineral sulfate to the desired dilution ratio;
transferring an amino acid from the second dry bin to the reactor and initiating a chelation reaction in the reactor; and
transferring the mineral amino acid complex resulting from the chelation reaction to the at least one day tank.

21. The method of preparing and delivering micronutrients using a modular premix batching and dispensing system as set forth in claim 20, further comprising the steps of:
providing the reactor with a heat source in thermal communication with a heat exchanger and wherein the heat exchanger is in fluid communication with the reactor;
transferring heat from the heat source to the heat exchanger;
circulating a process fluid between the heat exchanger and the reactor; and
heating the process fluid to a desired process temperature.

22. The method of preparing and delivering micronutrients using a modular premix batching and dispensing system as set forth in claim 21, wherein the step of transferring heat from the heat source to the heat exchanger comprises circulating heated water between the heat source and the heat exchanger.

23. The method of preparing and delivering micronutrients using a modular premix batching and dispensing system as set forth in claim 21, wherein the desired process temperature is at least approximately 130° F.

24. The method of preparing and delivering micronutrients using a modular premix batching and dispensing system as set forth in claim 21, wherein the desired process temperature is at least approximately 140° F.

25. The method of preparing and delivering micronutrients using a modular premix batching and dispensing system as set forth in claim 21, wherein the desired process temperature is between approximately 140° and approximately 160°.

26. The method of preparing and delivering micronutrients using a modular premix batching and dispensing system as set forth in claim 20, further comprising the step of monitoring a weight of dry mineral sulfate within at least one of the first dry bin, second dry bin, and reactor.

27. The method of preparing and delivering micronutrients using a modular premix batching and dispensing system as set forth in claim 20, further comprising the steps of:
storing a table of reference temperatures for process completion for at least one reference batch size in a memory associated with the first controller;
monitoring a first current process temperature within the reactor, generating a first temperature signal as a function of the first current process temperature and transmitting the first temperature signal to the first controller; and
comparing the first current temperature signal received from the thermostat with a corresponding reference temperature for a corresponding reference batch size from the table of reference temperature for process completion in the first controller.

28. The method of preparing and delivering micronutrients using a modular premix batching and dispensing system as set forth in claim 20, further comprising the steps of:
storing a table of reference times for process completion of at least one reference batch size in a memory associated with the first controller;
monitoring an actual time passed since initiation of operation of the reactor, generating a time signal as a function of the time elapsed since commencement of the process and transmitting the time signal to the first controller; and
comparing the time signal received from the timer with a corresponding reference time for a corresponding reference batch size from the table of reference times for process completion in the first controller.
